(19) United States
(12) Patent Application Publication
(10) Pub. No.: US 2024/0034832 A1
(43) Pub. Date: Feb. 1, 2024

(54) CURABLE COMPOSITION, CURED PRODUCT, OPTICAL MEMBER, AND OPTICAL DEVICE

(71) Applicant: DAICEL CORPORATION, Osaka-shi (JP)

(72) Inventors: Hiroki TAKENAKA, Tokyo (JP); Kouji TANAKA, Tokyo (JP)

(73) Assignee: DAICEL CORPORATION, Osaka-shi (JP)

(21) Appl. No.: 18/226,514

(22) Filed: Jul. 26, 2023

(30) Foreign Application Priority Data
Jul. 27, 2022 (JP) 2022-119766

(51) Int. Cl. C08G 59/24; G02B 1/04

(52) U.S. Cl. CPC C08G 59/24; G02B 1/041

(57) ABSTRACT

[Problem]

To provide a curable composition capable of achieving reduction in viscosity while having a high refractive index when formed into a cured product.

[Solution]

Disclosed is a curable composition containing an alicyclic epoxy compound (A) and a cationically polymerizable compound (B) having a binaphthyl group.

The curable composition preferably contains a monofunctional cationically polymerizable aromatic compound (C), preferably has a viscosity of 30 Pa·s or less at 25° C., and preferably has a refractive index of 1.58 or greater at a wavelength 589 nm when cured.

[Selected Drawing] None

### TECHNICAL FIELD

The present disclosure relates to a curable composition and a cured product thereof.

### BACKGROUND ART

With a demand for thinner and smaller optical lenses, there is a demand for a higher refractive index of a lens. As a method of thus improving the refractive index, an atomic group (aromatic or sulfur) having high atomic refraction or inorganic particles such as zirconia has been used.

For example, Patent Document 1 discloses that a high refractive index component is blended in a large amount to improve the refractive index, Patent Document 2 discloses that the refractive index is improved by using a high refractive index material including a specific epoxy compound and a fluorene compound, and Patent Documents 3 and 4 disclose that zirconia particles are blended to improve the refractive index.

### CITATION LIST

### Patent Document

Patent Document 1: JP 2019-8301 A

Patent Document 2: JP 2015-194547 A

Patent Document 3: JP 2011-34943 A

Patent Document 4: JP 2005-316219 A

### SUMMARY OF INVENTION

### Technical Problem

On the other hand, in Patent Document 1, there is a problem in that viscosity increases excessively and thus such a high viscosity impairs ease of handling. In addition, in Patent Documents 3 and 4, addition of zirconia, which is a high refractive index particle, tends to increase the viscosity and it is difficult to reduce the viscosity. When zirconia is added, preparation of fine particles and control of dispersion stability are required, making the process complicated.

The present disclosure solves such a problem. An object of the present disclosure is to provide a curable composition capable of achieving reduction in viscosity while having a high refractive index when formed into a cured product.

### Solution to Problem

As a result of intensive efforts to achieve the above object, the present disclosures have found that a curable composition containing an alicyclic epoxy compound (A) and a cationically polymerizable compound (B) having a binaphthyl group can achieve reduction in viscosity while having a high refractive index when formed into a cured product. The present disclosure has been completed based on these findings.

The present disclosure provides the curable composition containing the alicyclic epoxy compound (A) and the cationically polymerizable compound (B) having a binaphthyl group.

When the curable composition contains the alicyclic epoxy compound (A), the viscosity of the curable composition can be reduced. When the curable composition contains the cationically polymerizable compound (B) having a binaphthyl group, it is possible to achieve a high refractive index while suppressing an increase in viscosity.

The curable composition preferably contains a monofunctional cationically polymerizable aromatic compound (C). When the curable composition contains the monofunctional cationically polymerizable aromatic compound, it becomes easy to achieve further reduction in viscosity while maintaining a high refractive index, and ease of handling tends to be excellent.

A content of the monofunctional cationically polymerizable aromatic compound (C) is preferably from 1 to 30 mass % with respect to a total amount of the curable composition. When the content of the monofunctional cationically polymerizable aromatic compound (C) is within the above range, the viscosity can be easily reduced while maintaining a high refractive index.

The curable composition preferably has a viscosity of 30 Pa·s or less at 25° C. When the viscosity is within the above range, the liquid feeding properties of the curable composition by a pump and coatability are excellent.

The curable composition preferably has a refractive index of 1.58 or greater at a wavelength of 589 nm when cured. When the refractive index at a wavelength of 589 nm is within the above range, the composition can be preferably used as an optical lens.

The curable composition preferably has a refractive index of 1.55 or greater at a wavelength of 940 nm when cured. When the refractive index at a wavelength of 940 nm is within the above range, the composition can also be preferably used for near infrared applications.

A content of the cationically polymerizable compound (B) having a binaphthyl group is preferably from 5 mass % to 70 mass % with respect to the total amount of the curable composition. If the content of the cationically polymerizable compound (B) having a binaphthyl group is 5 mass % or greater, when the curable composition is formed into a cured product, the cured product tends to have a high refractive index. When the content of the cationically polymerizable compound (B) having a naphthyl group is 70 mass % or less, the viscosity can be further reduced.

A content of the alicyclic epoxy compound (A) is preferably from 10 mass % to 60 mass % with respect to the total amount of the curable composition. When the content of the alicyclic epoxy compound (A) is 10 mass % or greater, the curability and the reduction in viscosity of the composition the curable composition are further improved. When the content of the alicyclic epoxy compound (A) is 60 mass % or less, it is easy to impart optical characteristics having a high refractive index to the cured product.

The curable composition is preferably a thermosetting composition. In a case of an ultraviolet curable composition, curing a curable composition filled in an opaque mold is difficult. However, in a case of the thermosetting composition, the curable composition can be sufficiently cured by heating even when the opaque mold is used. In a case of an ultraviolet curable composition, reducing the viscosity by heating is easy, and thus the necessity of reducing the viscosity at a normal temperature is relatively low. Therefore, providing a thermosetting composition having a high refractive index and a low viscosity when formed into a cured product is very useful.

The curable composition is preferably a composition for forming a wafer lens.

The present disclosure also provides a cured product of the curable composition.

The present disclosure also provides an optical member having the cured product.

The present disclosure also provides an optical device including the optical member.

### Advantageous Effects of Invention

Since the curable composition of the present disclosure has the above configuration, the curable composition can achieve reduction in viscosity while having a high refractive index when formed into a cured product. Thus, it is possible to improve the liquid feeding properties of the curable composition by the pump and the coatability to the mold.

### DESCRIPTION OF EMBODIMENTS

### Curable Composition

A curable composition of the present disclosure is a curable composition containing an alicyclic epoxy compound (A) and a cationically polymerizable compound (B) having a binaphthyl group as essential components. The curable composition of the present disclosure may contain, for example, other components such as a cationic polymerizable component, an antioxidant, a release agent, and various additives described later, in addition to the essential components. The curable composition of the present disclosure can be used as a curable composition cured to form a cured product.

### Alicyclic Epoxy Compound (A)

The alicyclic epoxy compound (A) (hereinafter, may be referred to as “component (A)”) in the curable composition of the present disclosure is a compound having no ester group (ester bond) in the molecule, and is a compound having at least two epoxidized cyclic olefin groups in the molecule. The “epoxidized cyclic olefin group” included in the component (A) is a group (monovalent group) with one hydrogen atom removed from a structure in which at least one of carbon-carbon unsaturated bonds included in the cyclic olefin (a cycloaliphatic hydrocarbon in which at least one of carbon-carbon bonds forming a ring is a carbon-carbon unsaturated bond) is epoxidized, and may be hereinafter referred to as an “epoxidized cyclic olefin group” or an “alicyclic epoxy group”. That is, the epoxidized cyclic olefin group is a group including an aliphatic hydrocarbon ring structure and an epoxy group, the epoxy group being an epoxy group composed of two adjacent carbon atoms and oxygen atoms constituting the aliphatic hydrocarbon ring.

One or more substituents may be bonded to the aliphatic hydrocarbon ring forming the cyclic olefin group in the epoxidized cyclic olefin group. Examples of the substituent include substituents having 0 to 20 carbon atoms (more preferably 0 to 10 carbon atoms), and specific examples thereof include a halogen atom such as a fluorine atom, a chlorine atom, a bromine atom, and an iodine atom; a hydroxy group; an alkoxy group (preferably a C₁₋₆ alkoxy group, and more preferably a C₁₋₄ alkoxy group) such as a methoxy group, an ethoxy group, a propoxy group, an isopropyloxy group, a butoxy group, and an isobutyloxy group; an alkenyloxy group (preferably a C₂₋₆ alkenyloxy group, and more preferably a C₂₋₄ alkenyloxy group) such as an allyloxy group; an aryloxy group (preferably a C₆₋₁₄ 4 aryloxy group) that may have a substituent such as a C₁₋₄ alkyl group, a C₂₋₄ alkenyl group, a halogen atom, or a C₁₋₄ alkoxy group on an aromatic ring, such as a phenoxy group, a tolyloxy group, and a naphthyloxy group; an aralkyloxy group (preferably a C₇₋₁₈ aralkyloxy group) such as a benzyloxy group and a phenethyloxy group; an acyloxy group (preferably a C₁₋₁₂ acyloxy group) such as an acetyloxy group, a propionyloxy group, a (meth)acryloyloxy group, and a benzoyloxy group; a mercapto group; an alkylthio group (preferably a C₁₋₆ alkylthio group, and more preferably a C₁₋₄ alkylthio group) such as a methylthio group and an ethylthio group; an alkenylthio group (preferably a C₂₋₆ alkenylthio group, and more preferably a C₂₋₄ alkenylthio group) such as an allylthio group; an arylthio group (preferably a C₆₋₁₄ arylthio group) that may have a substituent such as a C₁₋₄ alkyl group, a C₂₋₄ alkenyl group, a halogen atom, or a C₁₋₄ alkoxy group on an aromatic ring, such as a phenylthio group, a tolylthio group, and a naphthylthio group; an aralkylthio group (preferably a C₇₋₁₈ aralkylthio group) such as a benzylthio group and a phenethylthio group; a carboxy group; an alkoxycarbonyl group (preferably a C₁₋₆ alkoxy-carbonyl group) such as a methoxycarbonyl group, an ethoxycarbonyl group, a propoxycarbonyl group, and a butoxycarbonyl group; an aryloxycarbonyl group (preferably a C₆₋₁₄ aryloxy-carbonyl group) such as a phenoxycarbonyl group, a tolyloxycarbonyl group, and a naphthyloxycarbonyl group; an aralkyloxycarbonyl group (preferably a C₇₋₁₈ aralkyloxy-carbonyl group) such as a benzyloxycarbonyl group; an amino group; a mono- or dialkylamino group (preferably a mono- or di-C₁₋₆ alkylamino group) such as a methylamino group, an ethylamino group, a dimethylamino group, and a diethylamino group; an acylamino group (preferably a C₁₋₁₁ acylamino group) such as an acetylamino group, a propionylamino group, and a benzoylamino group; an oxetanyl group-containing group such as an ethyloxetanyloxy group; an acyl group such as an acetyl group, a propionyl group, and a benzoyl group; an oxo group; and a group in which two or more of these are bonded via a C₁₋₆ alkylene group as necessary. In the present specification, the term “(meth)acryl” represents “acryl” and/or “methacryl” (either one of or both of “acrylic” and “methacryl”) and the same for the others.

Among them, the cyclic olefin group is preferably a cyclic olefin group having 5 to 12 carbon atoms, more preferably a cycloalkenyl group having 5 to 12 carbon atoms, and still more preferably a cyclohexenyl group. That is, the epoxidized cyclic olefin group is preferably a group formed by epoxidization of a cyclic olefin group having 5 to 12 carbon atoms, more preferably a group formed by epoxidization of a cycloalkenyl group having 5 to 12 carbon atoms, and still more preferably a group formed by epoxidization of a cyclohexenyl group (cyclohexene oxide group). The component (A) may have one type or two or more types of epoxidized cyclic olefin groups.

The number of epoxidized cyclic olefin groups in the molecule of the component (A) may be 2 or more, and is not particularly limited, but is preferably from 2 to 4, and more preferably 2.

The component (A) is preferably a compound having a structure in which at least two epoxidized cyclic olefin groups are bonded by a single bond or a divalent linking group.

Examples of the divalent linking group (divalent group having one or more atoms) include a divalent hydrocarbon group, an alkenylene group in which some or all of the carbon-carbon double bonds are epoxidized, a carbonyl group, an ether bond, an ester bond, a carbonate group, an amide group, and a group in which a plurality of the above groups are linked (for example, a group in which divalent hydrocarbon groups are linked via an ether bond). Examples of the divalent hydrocarbon group include a divalent aliphatic hydrocarbon group, a divalent alicyclic hydrocarbon group, and a group in which a plurality of those listed above are bonded. Examples of the divalent aliphatic hydrocarbon group include linear or branched alkylene groups (for example, an alkylene group having 1 to 6 carbon atoms) such as a methylene group, a methylmethylene group, a dimethylmethylene group, an ethylene group, a propylene group, a trimethylene group, and a tetramethylene group. Examples of the divalent alicyclic hydrocarbon group include divalent cycloalkylene groups such as a 1,2-cyclopentylene group, a 1,3-cyclopentylene group, a 1,2-cyclohexylene group, a 1,3-cyclohexylene group, and a 1,4-cyclohexylene group. Among them, a methylene group and an ether bond are preferable from the viewpoint of reducing the viscosity of the curable composition.

Specific examples of the component (A) include a compound represented by the following Formula (a1).

[Chem. 1]

R—X—R (a1)

In the above Formula (a1), R represents an epoxidized cyclic olefin group. Two Rs may be the same or different. X represents a single bond or a divalent linking group. Examples of the epoxidized cyclic olefin group for R and the divalent linking group for X are the same as those described above.

Specific examples of the compound represented by the above Formula (a1) include a compound represented by the following Formula (i).

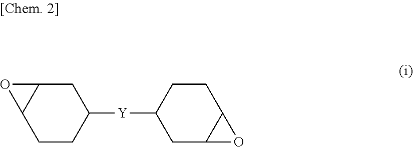

In the above Formula (i), Y represents a single bond or a divalent linking group. Examples of the divalent linking group include the same groups as described above. Note that substituents such as alkyl groups may be bonded to one or more of the carbon atoms constituting the cyclohexane ring (cyclohexene oxide group) in Formula (i).

From the viewpoint of reducing the viscosity of the curable composition, the component (A) may be a polycyclic compound having at least two epoxidized cyclic olefin groups directly bonded each other, and including two or more epoxy groups.

Examples of the polycyclic compound include those in which the epoxidized cyclic olefin groups share two or more carbon atoms to form a polycyclic structure. The polycyclic compound may form a ring structure of three or more rings by sharing two or more different carbon atoms in one ring structure, or three or more ring structures may all share two or more common carbon atoms. From the viewpoint of reducing the molecular size and the viscosity, a two ring structure is preferable.

Examples of the polycyclic compound include octahydro-2H-indeno [1,2-b:5,6-b′]bis(oxirene).

In the curable composition of the present disclosure, one type of the component (A) can be used alone, or two or more types thereof can be used in combination.

The content (blending amount) of the component (A) in the curable composition of the present disclosure is not particularly limited, and is preferably from 10 to 60 mass %, more preferably from 15 to 55 mass %, and still more preferably from 20 to 50 mass % with respect to the total amount (entire amount) of the curable composition. When the content of the component (A) is 10 mass % or greater, the curability and the reduction in viscosity of the curable composition are further improved. On the other hand, when the content of the component (A) is 60 mass % or less, it is easy to impart optical characteristics having a high refractive index to the cured product.

### Cationically Polymerizable Compound (B) Having Binaphthyl Group

The cationically polymerizable compound (B) (hereinafter, may be simply referred to as “component (B)”) having a binaphthyl group in the curable composition of the present disclosure is a compound having at least one binaphthyl group and at least one cationically curable functional group (cationically polymerizable functional group) in the molecule. When the curable composition includes the component (B), a high refractive index can be imparted when the curable composition of the present disclosure is formed into a cured product, while the curable composition maintains a low viscosity.

The number of binaphthyl groups in the component (B) may be two or more, and is preferably one from the viewpoint of solubility. One or more substituents may be bonded to the binaphthyl group. Examples of the substituent include those exemplified and described as the substituent which the aliphatic hydrocarbon ring forming the cyclic olefin group in the epoxidized cyclic olefin group may have.

Examples of the cationically curable functional group of the component (B) include known or commonly-used functional groups having cationic curability (cationically polymerizable), and are not particularly limited. Examples thereof include a cyclic ether group such as an epoxy group, an oxetanyl group, a tetrahydrofuranyl group, and an oxazolinyl group; a vinyl group-containing group such as a vinyl ether group and a styryl group; and a group containing at least these groups. Among them, from the viewpoint of solubility after synthesis, the cationically curable functional group is preferably a group containing an epoxy group, and more preferably a glycidyl group. The component (B) may have one type or two or more types of cationically curable functional groups.

The number of cationically curable functional groups in the molecule of the component (B) may be 1 or more, and is not particularly limited, but is preferably from 2 to 10, and more preferably from 2 to 4.

In the component (B), the cationically curable functional group may be directly bonded to the binaphthyl group or may be bonded thereto via the linking group. The cationically curable functional group is preferably bonded to at least the 1-position of the binaphthyl group, and is preferably bonded to the 1-position and the 1′-position.

In the curable composition of the present disclosure, one type of the component (B) can be used alone, or two or more types thereof can be used in combination.

The content (blending amount) of the component (B) in the curable composition of the present disclosure is not particularly limited, and is preferably from 5 to 70 mass %, more preferably from 7 to 65 mass %, and still more preferably from 10 to 60 mass % with respect to the total amount (entire amount) of the curable composition. If the content of the component (B) is 5 mass % or greater, when the curable composition is formed into a cured product, the cured product tends to have a high refractive index. When the content of the component (B) is 70 mass % or less, the viscosity can be further reduced.

### Monofunctional Cationically Polymerizable Aromatic Compound (C)

The curable composition of the present disclosure preferably contains a monofunctional cationically polymerizable aromatic compound (C) (hereinafter, may be simply referred to as “component (C)”). The component (C) is a compound having at least one aromatic ring and one cationically curable functional group (cationically polymerizable functional group) in the molecule. The cationically curable functional group may be directly bonded to the aromatic ring or bonded via the linking group.

The aromatic ring of the component (C) is not particularly limited, and examples thereof include an aromatic monocyclic hydrocarbon ring such as a benzene ring; and an aromatic hydrocarbon ring such as an aromatic condensed polycyclic hydrocarbon ring such as a naphthalene ring, an anthracene ring, a fluorene ring, and a pyrene ring. Examples of the aromatic ring include aromatic heterocyclic rings such as a pyridine ring, a furan ring, a pyrrole ring, a benzofuran ring, an indole ring, a carbazole ring, a quinoline ring, a benzimidazole ring, and a quinoxaline ring. Among them, the aromatic ring is preferably an aromatic hydrocarbon ring, and more preferably a benzene ring. The number of aromatic rings in the molecule of the component (C) may be 2 or more, and is preferably 1 from the viewpoint of reducing the molecular size and forming an asymmetric compound having a low melting point.

The aromatic ring may have a substituent besides the cationically polymerizable functional group. Examples of the substituent include the same substituents as those that may be bonded to an aliphatic hydrocarbon ring forming the cyclic olefin group described above.

Examples of the cationically polymerizable functional group contained in the component (C) include the same groups as those exemplified and described as the cationically curable functional group of the component (B). Among them, as the cationically curable functional group, a group containing an epoxy group is preferable, and a glycidyl group is more preferable.

In the component (C), the aromatic ring may have a substituent. Examples of the substituent include those exemplified and described as the substituent which the aliphatic hydrocarbon ring forming the cyclic olefin group in the epoxidized cyclic olefin group may have. Among them, a hydrocarbon group is preferable, and a hydrocarbon group having 1 to 4 carbon atoms is more preferable.

The component (C) is preferably a liquid at normal temperature from the viewpoint that the curable composition has a lower viscosity.

Examples of the component (C) include 2-(phenoxymethyl) oxirane, [(2-methylphenoxy) methyl] oxirane, [(2-ethylphenoxy) methyl] oxirane, [(2-propylphenoxy) methyl] oxirane, 2-[(2-methoxyphenoxy) methyl] oxirane, 2-[(2-ethoxyphenoxy) methyl] oxirane, 2-[(2-propoxyphenoxy) methyl] oxirane, 2-[(4-isopropylphenoxy) methyl] oxirane, P-sec-butylphenyl (glycidyl) ether, 2-(P-tert-butylphenoxymethyl) oxirane, {[4-(2-methoxyethyl) phenoxy] methyl} oxirane, 2-(P-tolyl) oxirane, and 3-methyl-2-phenyloxirane.

The content (blending amount) of the component (C) in the curable composition of the present disclosure is not particularly limited, and is preferably from 1 to 30 mass %, more preferably from 3 to 25 mass %, and still more preferably from 5 to 20 mass % with respect to the total amount (entire amount) of the curable composition. If the content of the component (C) is within the above range, the refractive index can be easily increased when a cured product is formed, while the viscosity of the curable composition is reduced.

### Other Cationically Polymerizable Compounds

The curable composition of the present disclosure may contain other cationically polymerizable compounds besides the components (A), (B), and (C). Examples of the other cationically polymerizable compounds include polyfunctional cationically polymerizable aromatic compounds other than the components (A) and (B).

The polyfunctional cationically polymerizable aromatic compound is a compound having at least one aromatic ring and at least two or more cationically curable functional groups (cationically polymerizable functional groups) in the molecule.

As the aromatic ring in the above polyfunctional cationically polymerizable aromatic compound, the same ones as those disclosed in the component (C) can be used. As the cationically curable functional group (cationically polymerizable functional group), the same groups as those disclosed in the component (B) can be used. Among them, the cationically curable functional group is preferably a group containing an epoxy group or a group containing an oxetanyl group.

Examples of the polyfunctional cationically polymerizable aromatic compound include a bisphenol A type epoxy compound (such as bisphenol A, and a diglycidyl ether which is an alkylene oxide adduct of bisphenol A), a bisphenol F type epoxy compound (such as bisphenol F, and a diglycidyl ether which is an alkylene oxide adduct of bisphenol F), a biphenol type epoxy compound, a phenol novolac type epoxy compound, a cresol novolac type epoxy compound, a cresol type epoxy compound, a cresol novolac type epoxy compound of bisphenol A, a polyphenol type epoxy compound, a brominated bisphenol A type epoxy compound, a brominated bisphenol F type epoxy compound, a hydroquinone diglycidyl ether, a resorcine glycidyl ether, a terephthalic acid diglycidyl ester, a phthalic acid diglycidyl ester, an addition reaction product of a terminal carboxylic acid polybutadiene and a bisphenol A type epoxy resin, a naphthalene type epoxy compound (an epoxy compound having a naphthalene ring), and an epoxy compound having a fluorene ring.

As the polyfunctional cationically polymerizable aromatic compound, a commercially available product can also be used. Examples of commercially available products of the bisphenol A type epoxy compound among the polyfunctional cationically polymerizable aromatic compounds include “jER 827”, “jER 828”, “jER 828 EL”, “jER 828 XA”, and “jER 834” (trade names, all available from Mitsubishi Chemical Corporation); and “EPICLON 840”, “EPICLON 840-S”, “EPICLON 850”, “EPICLON 850-S”, and “EPICLON 850-LC” (trade names, all available from DIC Corporation). Further, among the polyfunctional cationically polymerizable aromatic compounds, examples of commercially available products of the epoxy compound having a naphthalene ring in the molecule include “EPICLON HP 4032”, “HP 4032 D”, “HP 4700”, “HP 4710”, “HP 4770”, and “HP 5000” (trade names, all available from DIC Corporation). Further, among the polyfunctional cationically polymerizable aromatic compounds, examples of commercially available products of the epoxy compound having a fluorene ring in the molecule include “PG-100”, “EG-200”, and “EG-250” (trade names, all available from Osaka Gas Chemicals Co., Ltd.); and “ONCOAT EX-1010”, “ONCOAT EX-1011”, “ONCOAT EX-1012”, “ONCOAT EX-1020”, “ONCOAT EX-1030”, “ONCOAT EX-1040”, “ONCOAT EX-1050”, and “ONCOAT EX-1051” (trade names, all available from Nagase & Co., Ltd.). Furthermore, among the polyfunctional cationically polymerizable aromatic compounds, examples of commercially available products of the oxetane compound having an aromatic ring in the molecule include “OXT-121” and “OXT-211” (trade names, both available from Toagosei Co., Ltd.); and “ETERNACOLL OXBP” (trade name, available from UBE Corporation).

In the curable composition of the present disclosure, one type of the other cationically polymerizable aromatic compounds can be used alone, or two or more types thereof can be used in combination.

The content (blending amount) of the other cationically polymerizable aromatic compound in the curable composition of the present disclosure is not particularly limited, and is preferably from 5 to 60 mass %, more preferably from 10 to 55 mass %, and still more preferably from 15 to 50 mass % with respect to the total amount (entire amount) of the curable composition. If the content of the other cationically polymerizable aromatic compound is within the above range, the refractive index can be increased easily when a cured product is formed, while the viscosity of the curable composition is reduced.

### Cationic Curing Agent

The curable composition of the present disclosure preferably contains a cationic curing agent. Examples of the cationic curing agent include a photocationic curing agent and a thermal cationic curing agent.

The photocationic curing agent is a compound having a function of initiating or progressing a polymerization reaction (curing reaction) of a cationically curable compound (a compound having a cationically curable functional group; for example, the components (A), (B), and (C)) contained in the curable composition by light (light irradiation). As the photocationic curing agent, a known or commonly-used compound having the function described above can be used, and is not particularly limited, and examples thereof include a photocationic polymerization initiator that generates a cationic species by light irradiation and thereby initiates polymerization (curing) of a curable compound.

Examples of the cationic catalyst that generates a cationic species by light irradiation (particularly, ultraviolet irradiation) include a hexafluoroantimonate salt, a pentafluorohydroxyantimonate salt, a hexafluorophosphate salt, and a hexafluoroarsenate salt.

In the curable composition of the present disclosure, one type of photocationic curing agent can be used alone, or two or more types thereof can be used in combination.

The content (blending amount) of the photocationic curing agent in the curable composition of the present disclosure is not particularly limited, and is preferably from 0.001 to 10 parts by mass, more preferably from 0.01 to 5 parts by mass, and still more preferably from 0.1 to 3 parts by mass, with respect to 100 parts by mass of the total amount of the cationically polymerizable compound contained in the curable composition. When the content is less than 0.001 parts by mass, curing failure may easily occur particularly in the case of formation of a relatively thick cured product. On the other hand, when the content is more than 10 parts by mass, physical properties such as heat resistance of the cured product may decrease, which may be disadvantageous in terms of cost.

The curable composition of the present disclosure may contain a thermal cationic curing agent. The thermal cationic curing agent is a compound having a function of initiating or progressing a polymerization reaction (curing reaction) of a cationically polymerizable compound (a compound having a cationically curable functional group; for example, the components (A), (B), and (C)) contained in the curable composition by heating. As the thermal cationic curing agent, a known or commonly-used compound having the function described above can be used, and is not particularly limited, and examples thereof include a thermal cationic polymerization initiator that generates a cationic species by heating and thus initiates polymerization (curing) of a curable compound.

Examples of the thermal cationic curing agent include a thermal cationic polymerization initiator such as an aryl diazonium salt, an aryl iodonium salt, an aryl sulfonium salt, and an allene-ion complex. Examples of the thermal cationic curing agent include a thermal cationic polymerization initiator such as a compound of a chelate compound of a metal such as aluminum or titanium with acetoacetic acid or a diketone and a compound with a silanol such as triphenylsilanol, or a compound of a chelate compound of a metal such as aluminum or titanium with acetoacetic acid or a diketone and a compound with a phenol such as bisphenol S. As the thermal cationic curing agents, for example, it is possible to use commercially available products such as “PP-33”, “CP-66”, and “CP-77” (trade names, all available from Adeka Corporation); “FC-509” (trade name, available from 3M); “UVE1014” (trade name, available from General Electric); “SAN-AID SI-60L”, “SAN-AID SI-80L”, “SAN-AID SI-100L”, “SAN-AID SI-110L”, and “SAN-AID SI-150L (trade names, all available from Sanshin Chemical Industry Co., Ltd.); and “CG-24-61” (trade name, available from BASF).

In the curable composition of the present disclosure, one type of thermal cationic curing agent can be used alone, or two or more types thereof can be used in combination.

The content (blending amount) of the thermal cationic curing agent in the curable composition of the present disclosure is not particularly limited, and is preferably from 0.001 to 10 parts by mass, more preferably from 0.01 to 5 parts by mass, and still more preferably from 0.1 to 3 parts by mass, with respect to 100 parts by mass of the total amount of the cationically polymerizable compound contained in the curable composition. When the content is less than 0.001 parts by mass, curing failure may easily occur particularly in the case of forming a relatively thick cured product. On the other hand, when the content is more than 10 parts by mass, physical properties such as heat resistance of the cured product may degrade, and the composition may be disadvantageous in terms of cost.

### Antioxidant

The curable composition of the present disclosure may further contain an antioxidant. As the antioxidant, it is possible to use a known or commonly-used compound that can be used as the antioxidant, and the antioxidant is not particularly limited. Examples thereof include phenol-based antioxidants (phenol-based compounds), phosphorous-based antioxidants (phosphorous-based compounds), and sulfur-based antioxidants (sulfur-based compounds).

Examples of the phenol-based antioxidants include monophenols such as 2,6-di-t-butyl-p-cresol, butylated hydroxyanisole, 2,6-di-t-butyl-p-ethylphenol, and stearyl-β-(3,5-di-t-butyl-4-hydroxyphenyl) propionate; bisphenols such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), and 3,9-bis[1,1-dimethyl-2-{β-(3-t-butyl-4-hydroxy-5-methylphenyl)propionyloxy}ethyl]2,4,8,10-tetraoxaspiro[5.5]undecane; and polymeric phenols such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, 1,3,5-tris(3′,5′-di-t-butyl-4′-hydroxybenzyl)-s-triazine-2,4,6-(1H,3H,5H)trione, and tocophenol.

Examples of the phosphorus-based antioxidant include phosphites such as triphenyl phosphite, diphenylisodecyl phosphite, phenyldiisodecyl phosphite, tris(nonylphenyl)phosphite, diisodecyl pentaerythritol phosphite, tris(2,4-di-t-butylphenyl) phosphite, cyclic neopentanetetraylbis(octadecyl)phosphite, cyclic neopentanetetraylbis(2,4-di-t-butylphenyl)phosphite, cyclic neopentanetetraylbis(2,4-di-t-butyl-4-methylphenyl)phosphite, and bis[2-t-butyl-6-methyl-4-{2-(octadecyloxycarbonyl)ethyl}phenyl]hydrogen phosphite; and oxaphosphaphenanthrene oxides such as 9,10-dihydro-9-oxa-10-phosphaphenanthrene-10-oxide, and 10-(3,5-di-t-butyl-4-hydroxybenzyl)-9,10-dihydro-9-oxa-10-phosphaphenanthrene-10-oxide.

Examples of the sulfur-based antioxidants include dilauryl-3,3′-thiodipropionate, dimyristyl-3,3′-thiodipropionate, and distearyl-3,3′-thiodipropionate.

In the curable composition according to the present disclosure, one type of the antioxidant can be used alone, or two or more types thereof can be used in combination.

The content (blending amount) of the antioxidant in the curable composition of the present disclosure is not particularly limited, and is preferably from 0.001 to 15 parts by mass, more preferably from 0.01 to 10 parts by mass, and still more preferably from 0.1 to 5 parts by mass, with respect to 100 parts by mass of the total amount of the cationically polymerizable compound contained in the curable composition. When the content is less than 0.001 parts by mass, suppression of deterioration such as oxidation may be insufficient depending on the application. On the other hand, when the content is more than 15 parts by mass, physical properties such as heat resistance of the cured product may degrade, and the composition may be disadvantageous in terms of cost.

### Other Component

The curable composition of the present disclosure may contain other components such as additives as necessary in addition to the above-described components. Examples of the additives include known or commonly-used additives, and are not particularly limited, and examples thereof include a metal oxide particle, a rubber particle, a silicone-based or fluorine-based defoamer, a silane coupling agent, a filler, a plasticizer, a leveling agent, an antistatic agent, a flame retardant, a colorant, an ultraviolet absorber, an ion adsorbent, and a pigment. The content (blending amount) of these various additives is not particularly limited, but is preferably 5 mass % or less (for example, from 0 to 5 mass %) with respect to the curable composition. Although the curable composition of the present disclosure may contain a solvent, if the amount is too large, bubbles may form in the cured product; therefore, the amount is preferably 10 mass % or less (for example, from 0 to 10 mass %) and more preferably 1 mass % or less with respect to the curable composition.

A ratio of the total amount of the cationically polymerizable compound to the total amount of the curable compound (a compound having a radically curable functional group and a compound having a cationically curable functional group) contained in the curable composition of the present disclosure is not particularly limited, and is preferably 80 mass % or greater (for example, from 80 to 100 mass %), and more preferably 90 mass % or greater. When the ratio is less than 80 mass %, a cure shrinkage rate during curing may become too large, or it may be difficult to ensure transparency of the cured product.

A total ratio of the components (A) and (B) with respect to the total amount of the curable compound contained in the curable composition is preferably 30 mass % or greater, more preferably 40 mass % or greater, and still more preferably 50 mass % or greater. When the content ratio is 30 mass % or greater, both a high refractive index of the cured product and the reduction in viscosity of the composition can be more easily achieved.

A total ratio of the components (A), (B), and (C) with respect to the total amount of the curable compound contained in the curable composition is preferably 30 mass % or greater, more preferably 40 mass % or greater, and still more preferably 50 mass % or greater. When the content ratio is 30 mass % or greater, both a high refractive index of the cured product and the reduction in viscosity of the composition can be more easily achieved.

A content ratio of the curable compound having a biphenyl skeleton to the total amount of the curable compound contained in the curable composition is preferably 50 mass % or less, more preferably 40 mass % or less, and still more preferably 30 mass % or less. When the content ratio is 50 mass % or less, yellowing of the cured product can be suppressed, and transparency is excellent.

The curable composition may be either a photocurable composition or a thermosetting composition, and is preferably a thermosetting composition. In a case of a photocurable composition, curing a curable composition filled in an opaque mold is difficult. However, in a case of the thermosetting composition, the curable composition can be sufficiently cured by heating even when the opaque mold is used. With respect to a transparent resin mold used for the photocurable composition, a metal mold can be processed with high accuracy by a mold processing machine, and a cured product having a high accuracy in shape can be obtained. In a case of a photocurable composition, reducing the viscosity by heating is easy, and thus the necessity of reducing the viscosity at a normal temperature is relatively low. Therefore, providing a thermosetting composition having a high refractive index and a low viscosity when formed into a cured product is very useful.

The viscosity at 25° C. of the curable composition is preferably 30 Pa·s or less, more preferably 25 Pa·s or less, and still more preferably 20 Pa·s or less. When the viscosity at 25° C. of the curable composition is 30 Pa·s or less, feeding a liquid from a tank at the time of production is easy, and casting into a mold is also easy.

### Method for Producing Curable Composition

The curable composition of the present disclosure is not particularly limited, and can be prepared, for example, by blending a predetermined amount of the alicyclic epoxy compound (A), the cationically polymerizable compound (B) having a binaphthyl group, and, if necessary, the monofunctional cationically polymerizable aromatic compound (C) or other cationically polymerizable compounds, a cationic curing agent, an antioxidant, a release agent, various additives, and the like, and stirring and mixing them while removing air bubbles under vacuum if necessary. The temperature at the time of stirring and mixing is preferably, for example, about from 10 to 60° C. For stirring and mixing, a known or commonly-used apparatus, for example, a planetary centrifugal mixer, a single-axis or multi-axis extruder, a planetary mixer, a kneader, a dissolver, or the like can be used.

Since the curable composition prepared as described above has a low viscosity, the curable composition can be easily extracted from the prepared tank and can be easily cast into a mold during molding.

### Cured Product

The curable composition is cured by a known or common method to obtain a cured product. The refractive index at 589 nm (refractive index of light having a wavelength of 589 nm) (25° C.) of the cured product is not particularly limited, and is preferably 1.58 or greater, and more preferably 1.60 or greater. When the refractive index at a wavelength of 589 nm is 1.58 or greater, the composition can be preferably used as an optical lens.

The refractive index at 940 nm (refractive index of light having a wavelength of 940 nm) (25° C.) of the cured product is not particularly limited, and is preferably 1.55 or greater, more preferably 1.57 or greater, and still more preferably 1.58 or greater. When the refractive index at a wavelength of 940 nm is 1.55 or greater, the composition can be preferably used for near infrared applications in optical lenses.

The Abbe number of the cured product is not particularly limited, and is preferably 35 or less, more preferably 30 or less, and still more preferably 27 or less.

An external transmittance at 450 nm (external internal transmittance of light having a wavelength of 450 nm) of the cured product [in terms of a thickness of 0.5 mm] is not particularly limited, and is preferably 70% or greater (for example, from 70 to 100%), more preferably 75% or greater, still more preferably 80% or greater, and particularly preferably 85% or greater. When the external internal transmittance of the cured product at 450 nm is 70% or greater, a bright lens can be obtained when the cured product is used as a lens for visible light applications.

An internal transmittance at 450 nm (internal transmittance of light having a wavelength of 450 nm) of the cured product [in terms of a thickness of 0.5 mm] is not particularly limited, and is preferably 80% or greater (for example, from 80 to 100%), more preferably 85% or greater, still more preferably 90% or greater, and particularly preferably 95% or greater.

The external internal transmittance at 940 nm (external internal transmittance of light having a wavelength of 940 nm) of the cured product [in terms of a thickness of 0.5 mm] is not particularly limited, and is preferably 80% or greater (for example, from 80 to 100%), more preferably 83% or greater, still more preferably 86% or greater, and particularly preferably 89% or greater. When the external transmittance of the cured product at 940 nm is 80% or greater, a bright lens can be obtained when the cured product is used as a lens for near infrared applications.

An internal external transmittance at 940 nm (internal external transmittance of light having a wavelength of 940 nm) of the cured product [in terms of a thickness of 0.5 mm] is not particularly limited, and is preferably 90% or greater (for example, from 90 to 100%), more preferably 93% or greater, still more preferably 96% or greater, and particularly preferably 99% or greater.

The curable composition is excellent in rapid curability and shape stability during curing, and when the composition is cured, a cured product having high heat resistance and also having optical characteristics such as high transparency, high refractive index, and a low Abbe number can be formed. Thus, the curable composition of the present disclosure can be particularly preferably used as a material for forming an optical member (composition for forming an optical member). That is, the optical member includes a cured product formed by curing the curable composition (composition for forming an optical member) of the present disclosure. Examples of the optical member include a member exhibiting various optical functions such as light diffusibility, optical transparency, and light reflectivity, and a member constituting a device or equipment using the optical functions (these may be collectively referred to as an “optical device”). Specific examples of the optical member include a lens, a prism, an optical panel, a microlens, a head-up display, a mirror, a window, and an optical filter, and the optical member can be suitably used for a lens requiring high molding accuracy.

The type and shape of the lens are not particularly limited, and examples thereof include a lens for an optical equipment, a lens for an optoelectronic device, a lens for laser, a pick up lens, a lens for an on-board camera, a lens for a mobile camera, a lens for a digital camera, a Fresnel lens, a microlens, and a wafer-level lens. The optical member can be preferably applied to a wafer-level lens that is required to be compact, thin, and highly precise.

The optical member described above is used to produce an optical device having the optical member. The optical device is exemplified by, but not limited to, various optical devices including any of the optical members described above, and such an optical device can be a liquid crystal display device, an optical semiconductor display device, a plasma display panel, an organic electroluminescence display, a field emission display, and a portable terminal such as a smartphone and a mobile phone).

Each aspect disclosed in the present specification can be combined with any other feature disclosed herein. The configurations, combinations thereof, and the like in each embodiment are examples, and various configurational additions, omissions, and other changes may be made, as appropriate, without departing from the spirit of the present disclosure. The present disclosure is not limited by the embodiments and is limited only by the claims.

### EXAMPLES

An embodiment of the present disclosure will be described in further detail below based on examples.

### Curable Composition

### Examples 1 to 6, Comparative Examples 1 to 8

Each component shown in Table 1 was blended according to a blending composition (the values are represented in parts by mass) shown in Table 1, and stirred and mixed by a planetary centrifugal mixer at room temperature to obtain a uniform and transparent curable composition (cationically curable composition).

### Details of Each Component

Hereinafter, details of each component in the table will be described.

Binaphthyl group-containing cationically polymerizable compound: trade name “DGOBINL”, available from Sugai Chemical Industry Co., Ltd.

Other cationically polymerizable compound A: 1,6-bis (2,3-epoxypropan-1-yloxy) naphthalene Trade name “HP-4032D”, available from DIC Corporation

Other cationically polymerizable compound B: trade name “OGSOL PG-100”, available from Osaka Gas Chemicals Co., Ltd.

Other cationically polymerizable compound C: trade name “OGSOL EG-200”, available from Osaka Gas Chemicals Co., Ltd.

Other cationically polymerizable compound D: trade name “jER827”, available from Mitsubishi Chemical Corporation

Other cationically polymerizable compound E: trade name “ETERNACOLL OXBP”, available from UBE Corporation

Monofunctional cationically polymerizable aromatic compound: trade name “OCR-EP”, available from Yokkaichi Chemical Co., Ltd.

Alicyclic epoxy compound A: 3,4,3′,4′-diepoxybicyclohexane

Alicyclic epoxy compound B: bis(3,4-epoxycyclohexylmethyl)ether

Thermal cationic polymerization initiator: trade name “SAN-AID SI-100 L”, available from Sanshin Chemical Industry Co., Ltd.

Antioxidant A: pentaerythritol tetrakis (3-(3,5-ditertiarybutyl-4-hydroxyphenyl) propionate), trade name “Irganox 1010” available from BASF

Antioxidant B: 2,2′-methylenebis (4,6-di-tert-butylphenyl) 2-ethylhexylphosphite trade name “Adeka Stab HP-10”, available from Adeka Corporation

Next, the curable compositions obtained in Examples and Comparative Examples were cured by the following heat treatment method to obtain cured products.

### Heating Treatment Method

Each curable composition was cured and molded to a thickness of 0.5 mm at 170° C. for 10 minutes using an imprint molding machine (trade name “NANOIMPRINTER NM-0501”, available from Meisho Kiko Co.) in a molding profile below, cooled down to 100° C., then removed from the mold, further heated in an oven, which was preheated at 200° C., for 30 minutes for annealing, and thus a cured product was obtained.

The obtained curable composition and cured product were evaluated as follows.

### Evaluation

### (1) Refractive Index

In the cured product, the refractive indices at wavelengths of 451 nm, 594 nm, 655 nm, and 938 nm at 25° C. were measured by a method in accordance with JIS K 7142, using a refractometer (trade name “Model 2010”, available from Metricon Corporation), and the refractive indices at wavelengths of 589 nm and 940 nm were calculated by the Cauchy's dispersion equation.

### (2) Abbe Number

The Abbe number of the cured product was calculated by the following equation.

Abbe number=(nd−1)/(nF−nC).

(In the formula, nd represents the refractive index at 589.2 nm, nF represents the refractive index at 486.1 nm, and nC represents the refractive index at 656.3 nm. As the value of the refractive index, the above-described method of measuring the refractive index was used, and the value of the refractive index obtained at each wavelength described above was used.)

### (3) Appearance

The appearance of the cured product was visually evaluated as follows. ◯: Clear to light yellow, x: yellow

### (4) Viscosity

The viscosity of the curable composition was measured as the viscosity (Pa·s) at 25° C. at a rotation speed of D=20/s using a rheometer (trade name “Physica UDS 200”, available from Paar Physica).

### (5) Transmittance

The external transmittance at 450 nm and 940 nm of the cured product was measured using a near infrared microspectrophotometer (trade name “USPM-RU-W”, available from Olympus Corporation). The internal transmittance was calculated by the following equation.

The internal transmittance at 450 nm or 940 nm=light transmittance at 450 nm or 940 nm/(1−r)²r={(n−1)/(n+1)}². n was the refractive index at 450 nm or 940 nm, was measured in accordance with the above-described method of measuring the refractive index, and calculated by the Cauchy's dispersion equation.

TABLE 1

| | | | | | | | Comparative |
|---|---|---|---|---|---|---|---|
| | Examples | | | | | | Examples |
| | 1 | 2 | 3 | 4 | 5 | 6 | 1 |
| Binaphthyl group-containing cationically curable compound | 50 | 40 | 20 | 50 | 10 | 40 | — |
| Other cationically polymerizable compound A | — | — | — | — | — | — | 50 |
| Other cationically polymerizable compound B | — | — | 25 | — | 30 | — | — |
| Other cationically polymerizable compound C | — | — | — | — | — | — | — |
| Other cationically polymerizable compound D | — | 30 | 15 | — | 15 | 15 | — |
| Other cationically polymerizable compound E | — | — | — | 20 | — | — | — |
| Monofunctional cationically polymerizable aromatic compound | — | — | — | — | 15 | 15 | — |
| Alicyclic epoxy compound A | 50 | 30 | 40 | 30 | 30 | 30 | 50 |
| Alicyclic epoxy compound B | — | — | — | — | — | — | — |
| Thermal cationic polymerization initiator | 0.5 | 0.5 | 0.5 | 0.5 | 0.5 | 0.5 | 0.5 |
| Antioxidant A | 0.5 | 0.5 | 0.5 | 0.5 | 0.5 | 0.5 | 0.5 |
| Antioxidant B | 0.5 | 0.5 | 0.5 | 0.5 | 0.5 | 0.5 | 0.5 |
| Total | 101.5 | 101.5 | 101.5 | 101.5 | 101.5 | 101.5 | 101.5 |
| Refractive index (589 nm) | 1.602 | 1.604 | 1.599 | 1.609 | 1.597 | 1.601 | 1.578 |
| Refractive index (940 nm) | 1.584 | 1.584 | 1.581 | 1.591 | 1.580 | 1.583 | 1.563 |
| Abbe number | 26.4 | 26.3 | 27.6 | 25.7 | 29.0 | 26.8 | 31.2 |
| External transmittance (450 nm) | 80 | 81 | 85 | 79 | 88 | 81 | 64 |
| External transmittance (940 nm) | 91 | 90 | 91 | 89 | 91 | 91 | 92 |
| Internal transmittance (450 nm) | 90 | 91 | 95 | 89 | 98 | 91 | 71 |
| Internal transmittance (940 nm) | 100 | 100 | 100 | 100 | 100 | 100 | 100 |
| Appearance | ∘ | ∘ | ∘ | ∘ | ∘ | ∘ | x |
| Viscosity (25° C.) | 3.9 | 15.0 | 23.7 | 17.4 | 4.0 | 2.1 | 1.0 |

| | Comparative Examples | | | | | | |
|---|---|---|---|---|---|---|---|
| | 2 | 3 | 4 | 5 | 6 | 7 | 8 |
| Binaphthyl group-containing cationically curable compound | — | — | — | — | — | — | — |
| Other cationically polymerizable compound A | 40 | — | — | — | — | — | — |
| Other cationically polymerizable compound B | — | 30 | 40 | 32 | 50 | 40 | 30 |
| Other cationically polymerizable compound C | — | 30 | 20 | 35 | — | — | 40 |
| Other cationically polymerizable compound D | 30 | — | — | — | — | 20 | — |
| Other cationically polymerizable compound E | — | — | — | — | — | — | — |
| Monofunctional cationically polymerizable aromatic compound | — | — | — | — | — | — | — |
| Alicyclic epoxy compound A | 30 | 40 | 40 | 33 | 50 | 40 | |
| Alicyclic epoxy compound B | — | — | — | — | — | — | 30 |
| Thermal cationic polymerization initiator | 0.5 | 0.4 | 0.4 | 0.4 | 0.4 | 0.4 | 0.4 |
| Antioxidant A | 0.5 | 1 | 1 | 1 | 1 | 1 | 1 |
| Antioxidant B | 0.5 | — | — | — | — | — | — |
| Total | 101.5 | 101.4 | 101.4 | 101.4 | 101.4 | 101.4 | 101.4 |
| Refractive index (589 nm) | 1.587 | 1.595 | 1.598 | 1.604 | 1.584 | 1.589 | 1.604 |
| Refractive index (940 nm) | 1.571 | 1.577 | 1.580 | 1.585 | — | — | — |
| Abbe number | 30.0 | 27.9 | 27.6 | 26.9 | 30.0 | 28.0 | 27.0 |
| External transmittance (450 nm) | 58 | 89 | 89 | 89 | 89 | 89 | 89 |
| External transmittance (940 nm) | 91 | 91 | 91 | 91 | 91 | 91 | 91 |
| Internal transmittance (450 nm) | 65 | 100 | 100 | 100 | — | — | — |
| Internal transmittance (940 nm) | 100 | 100 | 100 | 100 | — | — | — |
| Appearance | x | ∘ | ∘ | ∘ | ∘ | ∘ | ∘ |
| Viscosity (25° C.) | 2.7 | 57 | 100 | 255 | 31 | 180 | 700 |

As shown in Examples 1 to 6, it was confirmed that in the curable composition containing the binaphthyl group-containing cationically polymerizable compound and the alicyclic epoxy compound, the viscosity was reduced while a high refractive index was maintained. On the other hand, in Comparative Examples 1 to 2, the refractive index was lower than that in Examples, and yellowing of the cured product could not be suppressed. In Comparative Examples 3 to 8, although the refractive index was high, the viscosity was too high, so that handleability was difficult.

Hereinafter, variations of the invention according to the present disclosure will be described.

### Appendix 1

A curable composition containing an alicyclic epoxy compound (A) and a cationically polymerizable compound (B) having a binaphthyl group.

### Appendix 2

The curable composition according to Appendix 1 containing a monofunctional cationically polymerizable aromatic compound (C).

### Appendix 3

The curable composition according to Appendix 2, wherein a content of the monofunctional cationically polymerizable aromatic compound (C) is from 1 mass % to 30 mass % with respect to a total amount of the curable composition.

### Appendix 4

The curable composition according to any one of Appendices 1 to 3, wherein a viscosity at 25° C. is 30 Pa·s or less.

### Appendix 5

The curable composition according to any one of Appendices 1 to 4, wherein a refractive index at a wavelength of 589 nm is 1.58 or greater when the curable composition is cured.

### Appendix 6

The curable composition according to any one of Appendices 1 to 5, wherein a refractive index at a wavelength of 940 nm is 1.55 or greater when the curable composition is cured.

### Appendix 7

The curable composition according to any one of Appendices 1 to 6, wherein a content of the cationically polymerizable compound (B) having the binaphthyl group is from 5 mass % to 70 mass % with respect to a total amount of the curable composition.

### Appendix 8

The curable composition according to any one of Appendices 1 to 7, wherein a content of the alicyclic epoxy compound (A) is from 10 mass % to 60 mass % with respect to a total amount of the curable composition.

### Appendix 9

The curable composition according to any one of Appendices 1 to 8, wherein the curable composition is a thermosetting composition.

### Appendix 10

The curable composition according to any one of Appendices 1 to 9, wherein the curable composition is a composition for forming a wafer lens.

### Appendix 11

A cured product of the curable composition described in any one of Appendices 1 to 10.

### Appendix 12

An optical member including the cured product described in Appendix 11.

### Appendix 13

An optical device including the optical member described in Appendix 12.

1. A curable composition comprising an alicyclic epoxy compound (A) and a cationically polymerizable compound (B) having a binaphthyl group.

2. The curable composition according to claim 1, further comprising a monofunctional cationically polymerizable aromatic compound (C).

3. The curable composition according to claim 2, wherein a content of the monofunctional cationically polymerizable aromatic compound (C) is from 1 mass % to 30 mass % with respect to a total amount of the curable composition.

4. The curable composition according to claim 1, wherein a viscosity at 25° C. is 30 Pa·s or less.

5. The curable composition according to claim 1, wherein a refractive index at a wavelength of 589 nm is 1.58 or greater when the curable composition is cured.

6. The curable composition according to claim 1, wherein a refractive index at a wavelength of 940 nm is 1.55 or greater when the curable composition is cured.

7. The curable composition according to claim 1, wherein a content of the cationically polymerizable compound (B) having the binaphthyl group is from 5 mass % to 70 mass % with respect to a total amount of the curable composition.

8. The curable composition according to claim 1, wherein a content of the alicyclic epoxy compound (A) is from 10 mass % to 60 mass % with respect to a total amount of the curable composition.

9. The curable composition according to claim 1, wherein the curable composition is a thermosetting composition.

10. The curable composition according to claim 1, wherein the curable composition is a composition for forming a wafer lens.

11. A cured product of the curable composition described in claim 1.

12. An optical member comprising the cured product described in claim 11.

13. An optical device comprising the optical member described in claim 12.
